(19) United States
(12) Patent Application Publication
(10) Pub. No.: US 2026/0066744 A1
(43) Pub. Date: Mar. 5, 2026

(54) COOLING SYSTEM FOR A SUPERCONDUCTING GENERATOR

(71) Applicant: General Electric Renovables España, S.L., Barcelona (ES)

(72) Inventor: James Michael Fogarty, Schenectady, NY (US)

(21) Appl. No.: 19/107,178

(22) PCT Filed: Aug. 29, 2022
(86) PCT No.: PCT/US2022/041828

§ 371 Date: Feb. 27, 2025

(51) Int. Cl. H02K 9/19; F03D 9/25; F03D 80/60; H02K 7/18

(52) U.S. Cl. CPC H02K 9/19; F03D 9/25; F03D 80/60; H02K 7/183; F05D 2220/76

(57) ABSTRACT

An electrical machine includes a shaft, a carrier structure arranged circumferentially around the shaft and defining a circumferential surface, a plurality of conducting coils secured to the carrier structure, and a cooling system. The cooling system includes an inlet manifold for providing a cooling fluid to the electrical machine, an outlet manifold for removing the cooling fluid from the electrical machine, and at least one passageway in fluid communication with the inlet manifold and the outlet manifold. The at least one passageway is arranged between two adjacent conducting coils of the plurality of conducting coils. The at least one passageway defines an inlet portion including a fluid inlet in fluid communication with the inlet manifold, an outlet portion including a fluid outlet in fluid communication with the outlet manifold, and a return portion arranged between the inlet portion and the outlet portion. The return portion defines a length such that the inlet portion and the outlet portion are arranged in contact with each other along respective lengths of the inlet and outlet portions so that a conductive potential of the at least one passageway is reduced.

### STATEMENT REGARDING FEDERALLY SPONSORED RESEARCH OR DEVELOPMENT

This invention was made with Government support under Contract No. DE-EE0008787 awarded by the Department of Energy (DOE). The Government has certain rights in the invention.

### FIELD

The present disclosure relates generally to cooling systems, and more particularly to cooling systems for superconducting generators.

### BACKGROUND

Wind power is considered one of the cleanest, most environmentally friendly energy sources presently available, and wind turbines have gained increased attention in this regard. A modern wind turbine typically includes a tower, a generator, a gearbox, a nacelle, and a rotatable hub having one or more rotor blades mounted thereto. The rotor blades are typically mounted to the hub via respective pitch bearings that allow rotation of each of the rotor blades about a pitch axis. Thus, the rotor blades capture the kinetic energy of wind using known airfoil principles. For example, the rotor blades typically have the cross-sectional profile of an airfoil such that, during operation, air flows over the rotor blades producing a pressure difference between the sides. Consequently, a lift force, which is directed from a pressure side towards a suction side, acts on each of the rotor blades. The lift force generates torque on the main rotor shaft, which can directly drive a generator or be geared to a generator for producing electricity.

Generally, generators or electric motors (collectively referred to herein as conducting rotating machines) include a plurality of conducting coils for generating a static or rotating magnetic field and at least one armature coil for generating a rotating magnetic field or a stationary magnetic field in relation to the motion of the armature that interacts with the field from the conducting coils.

Such conducting rotating machines typically take advantage of alternating magnetic polarities established by the conducting coils of the field windings. That is, north poles are located between south poles to create a regular north, south, north, south, etc. field pattern. These alternating polarities are generated by relying on conducting coils of the field windings constructed of conductors which generate current in opposing directions. The magnetic fields generated by the field coils interact with the magnetic poles of the conducting coils of the armature to create torque. Torque is produced by the interaction of two magnetic fields attempting to align. The magnitude of the torque is related to the strength of the magnetic fields and radius at which they interact.

Many such generators may also include a cooling system to assist with cooling the conducting coils to maintain the conducting coils and surrounding insulation at a suitable temperature.

Generator cooling systems may require several mechanical connections to effectively provide cooling to each of the conducting coils. However, as the number of mechanical connections increase, the possibility of the failure of the overall cooling system may increase. Further, the cost of manufacturing the mechanical connections may lead to the increase in the overall cost of producing a generator.

In addition, such cooling systems may also experience increased heat as a consequence of being placed in proximity to other components of the generator. This may occur when magnetic flux passes through the cooling system and leads to the generation of eddy currents within the cooling system. These eddy currents may cause the cooling system to conduct the current along the cooling system. Such conduction of current may cause the overall resistance of the cooling system (particularly, the materials used to construct the cooling system) to increase. With an increase in resistance, the thermal load exerted upon the cooling system is increased. This increased thermal load will result in the cooling system heating up which will lead to a reduction in the overall capability of the cooling system to cool components external to the cooling system. If the capability of the cooling system is reduced, the components to be cooled may also operate less efficiently as a result of the components operating at suboptimal temperatures.

Thus, the industry is continuously seeking new and improved cooling systems for generators that address the aforementioned issues.

### BRIEF DESCRIPTION

Aspects and advantages of the disclosure will be set forth in part in the following description, or may be obvious from the description, or may be learned through practice of the disclosure.

In one aspect, the present disclosure is directed to an electrical machine. The electrical machine includes a shaft, a carrier structure arranged circumferentially around the shaft and defining a circumferential surface, a plurality of conducting coils secured to the carrier structure, and a cooling system. The cooling system includes an inlet manifold for providing a cooling fluid to the electrical machine, an outlet manifold for removing the cooling fluid from the electrical machine, and at least one passageway in fluid communication with the inlet manifold and the outlet manifold. The at least one passageway is arranged between two adjacent conducting coils of the plurality of conducting coils. The at least one passageway defines an inlet portion including a fluid inlet in fluid communication with the inlet manifold, an outlet portion including a fluid outlet in fluid communication with the outlet manifold, and a return portion arranged between the inlet portion and the outlet portion. The return portion defines a length such that the inlet portion and the outlet portion are arranged in contact with each other along respective lengths of the inlet and outlet portions so that a conductive potential of the at least one passageway is reduced. These and other features, aspects and advantages of the present disclosure will become better understood with reference to the following description and appended claims. The accompanying drawings, which are incorporated in and constitute a part of this specification, illustrate embodiments of the disclosure and, together with the description, serve to explain the principles of the disclosure.

In an embodiment, the carrier structure is an armature or a yoke of a field assembly.

In further embodiments, the electrical machine further includes a first divider arranged along the respective lengths of the inlet and outlet manifolds for providing flow separation between the inlet and outlet manifolds.

In additional embodiments, the first divider is constructed of a material with a thermal conductivity lower than about 45 watts per meter-kelvin (W/m-K)

In other embodiments, the first divider is constructed of a non-metallic material.

In still further embodiments, the electrical machine further includes a cooling inlet and a cooling outlet wherein the cooling system defines a module, wherein at least one module is connected to the cooling inlet and the cooling outlet.

In other additional embodiments, the cooling inlet is connected to the inlet manifold of the at least one module and the cooling outlet is connected to the outlet manifold of the at least one module.

In further additional embodiments, the connections between the cooling inlet and outlet and the inlet and outlet manifolds include flexible connectors.

In still other embodiments, the electrical machine further includes a second divider arranged along the respective lengths of the inlet and outlet portions for providing flow separation between the inlet and outlet portions.

In yet another embodiment, the second divider is constructed of a material with a thermal conductivity lower than about 45 watts per meter-kelvin (W/m-K).

In further embodiments, the second divider is constructed of a non-metallic material.

In additional embodiments, the cooling fluid includes at least one of water, coolant, antifreeze, gas, or combinations thereof.

In other embodiments, the inlet and outlet manifolds and the inlet and outlet portions are constructed of an electrically conductive material.

In still further embodiments, the cooling system further includes at least two passageways in fluid communication with the inlet manifold and the outlet manifold, the at least two passageways arranged between two adjacent conducting coils of the plurality of conducting coils.

In another aspect, the present disclosure is directed to a method of cooling an electrical machine having a plurality of conducting coils. The method includes arranging at least one passageway between two adjacent conducting coils of the plurality of conducting coils, the at least one passageway being in fluid communication with an inlet manifold that provides cooling fluid to the electrical machine and an outlet manifold that removes the cooling fluid from the electrical machine. The at least one passageway defines an inlet portion including a fluid inlet in fluid communication with the inlet manifold, an outlet portion including a fluid outlet in fluid communication with the outlet manifold, and a return portion arranged between the inlet portion and the outlet portion. The return portion defines a length such that the inlet portion and the outlet portion are arranged in contact with each other along respective lengths of the inlet and outlet portions so as to provide electrical insulation thereto. The method further includes operating the inlet manifold and the outlet manifold to provide the cooling fluid to the at least one passageway so as to cool the two adjacent conducting coils of the plurality of conducting coils.

In yet another aspect, the present disclosure is directed to a wind turbine. The wind turbine includes a generator including a shaft, a carrier structure arranged circumferentially around the shaft and defining a circumferential surface, a plurality of conducting coils secured to the carrier structure, and a cooling system. The cooling system includes an inlet manifold for providing a cooling fluid to the electrical machine, an outlet manifold for removing the cooling fluid from the electrical machine, and at least one passageway in fluid communication with the inlet manifold and the outlet manifold. The at least one passageway is arranged between two adjacent conducting coils of the plurality of conducting coils. The at least one passageway defines an inlet portion including a fluid inlet in fluid communication with the inlet manifold, an outlet portion including a fluid outlet in fluid communication with the outlet manifold, and a return portion arranged between the inlet portion and the outlet portion. The return portion defines a length such that the inlet portion and the outlet portion are arranged in contact with each other along respective lengths of the inlet and outlet portions so that a conductive potential of the at least one passageway is reduced. These and other features, aspects, and advantages of the present disclosure will become better understood with reference to the following description and appended claims. The accompanying drawings, which are incorporated in and constitute a part of this specification, illustrate embodiments of the disclosure and, together with the description, serve to explain the principles of the disclosure.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 illustrates a side, perspective view of an embodiment of a wind turbine with a generator according to the present disclosure;

FIG. 2 illustrates an internal, perspective view of an embodiment of a nacelle of the wind turbine of FIG. 1, particularly illustrating a generator housed in the nacelle according to the present disclosure;

FIG. 3 illustrates a perspective view of an embodiment of a generator according to the present disclosures;

FIG. 4 illustrates a schematic view of an embodiment of a cooling system for a generator according to the present disclosure;

FIG. 5 illustrates a side view of the cooling system of FIG. 4 according to the present disclosure, particularly illustrating a passageway of the cooling system;

FIG. 6 illustrates a schematic view of another embodiment of a cooling system for generator according to the present disclosure;

FIG. 7 illustrates a side view of the cooling system of FIG. 6 according to the present disclosure, particularly illustrating a passageway of the cooling system;

FIG. 8 illustrates a side view of yet another embodiment of a cooling system for a generator according to the present disclosure, particularly illustrating multiple passageways of the cooling system;

FIG. 9 illustrates a side view of still another embodiment of a cooling system of a generator according to the present disclosure, particularly illustrating a passageway of the cooling system;

FIG. 10 illustrates a schematic diagram of another embodiment of a cooling system of a generator, particularly connections of individual cooling systems; and

FIG. 11 illustrates a flow diagram of an embodiment of a method of cooling a generator having a plurality of conducting coils according to the present disclosure.

### DETAILED DESCRIPTION

Reference now will be made in detail to embodiments of the disclosure, one or more examples of which are illustrated in the drawings. Each example is provided by way of explanation of the disclosure, not limitation of the disclosure. In fact, it will be apparent to those skilled in the art that various modifications and variations can be made in the present disclosure without departing from the scope or spirit of the disclosure. For instance, features illustrated or described as part of one embodiment can be used with another embodiment to yield a still further embodiment. Thus, it is intended that the present disclosure covers such modifications and variations as come within the scope of the appended claims and their equivalents.

As used herein, the terms “first”, “second”, and “third” may be used interchangeably to distinguish one component from another and are not intended to signify location or importance of the individual components.

The terms “coupled,” “fixed,” “attached to,” and the like refer to both direct coupling, fixing, or attaching, as well as indirect coupling, fixing, or attaching through one or more intermediate components or features, unless otherwise specified herein.

Approximating language, as used herein throughout the specification and claims, is applied to modify any quantitative representation that could permissibly vary without resulting in a change in the basic function to which it is related.

Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

In general, the present disclosure is directed to an energy conversion system, such as a wind turbine power system, which includes an electric machine, such as a superconducting generator or motor. The present disclosure is described herein with reference to a superconducting generator in general, and more particularly to a wind turbine superconducting generator, but is not limited to superconducting generators. For example, the present disclosure is directed to a generator that includes a shaft, a carrier structure, a plurality of conducting coils, and a cooling system. The cooling system may include an inlet manifold for providing a cooling fluid to the generator, an outlet manifold for removing the cooling fluid from the generator, and a passageway in fluid communication with the inlet manifold and the outlet manifold. Further, the passageway can be arranged between two adjacent conducting coils of the plurality of coils.

Thus, an advantage of the present disclosure is to reduce the total required mechanical connections required for the cooling system needed to provide proper cooling to the generator. Another advantage of the present disclosure is that the reliability of the cooling system may be increased as a result of the reduced number of overall required mechanical connections. Further, the overall manufacturing cost of the cooling system may be reduced as less parts and mechanical connections are required. Yet another advantage of the present disclosure is that the cooling system may be more resistant to temperature increases as a consequence of eddy currents forming within the cooling system.

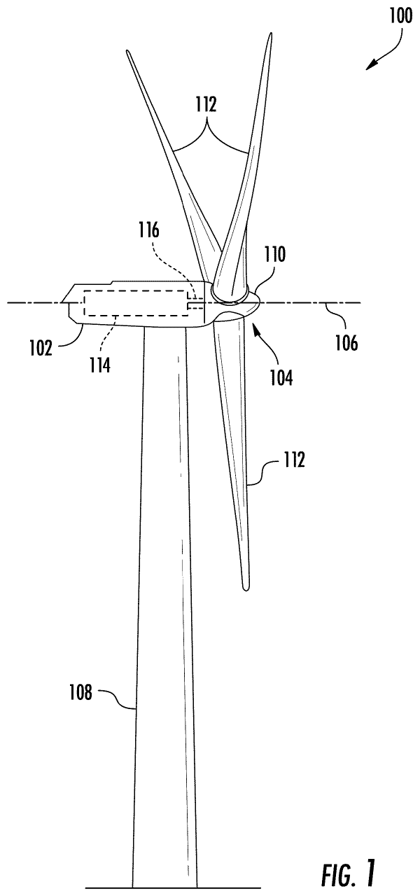

Referring now to the drawings, FIG. 1 illustrates a side, perspective view of an embodiment of a wind turbine 100 having a superconducting generator 114 according to the present disclosure. As shown, the wind turbine 100 generally includes a tower 108 extending from a support surface, a nacelle 102 mounted on the tower 108, and a rotor 104 coupled to the nacelle 102. The rotor 104 includes a rotatable hub 110 and at least one rotor blade 112 (three are shown) coupled to and extending outwardly from the hub 110. Each rotor blade 112 may be spaced about the hub 110 to facilitate rotating the rotor 104 about an axis of rotation 106 to enable kinetic energy to be transferred from the wind into usable mechanical energy, and subsequently, electrical energy. For this purpose, the rotor 104 is coupled to a generator 114 via a shaft (not shown). For purposes of the present disclosure, the generator 114 is a direct drive superconducting generator. A superconducting generator is distinguished from a non-superconducting generator by the presence of coils being constructed from a superconducting material (“superconductor”) instead of the normally conducting material with an electrical resistance (e.g., copper, aluminum, etc.). However, for the material of the superconductor to exist in a non-resistive, superconducting state, the superconductor must be kept below a certain temperature (“critical temperature”). Thus, an improved cooling system, for example for the non-superconducting coils, may be particularly useful within a superconducting generator by reducing the overall temperature of the generator thus minimizing heat leakage into the superconducting conducting coils. However, it should be construed that the improved cooling system may also provide utility to a generator with non-superconducting coils.

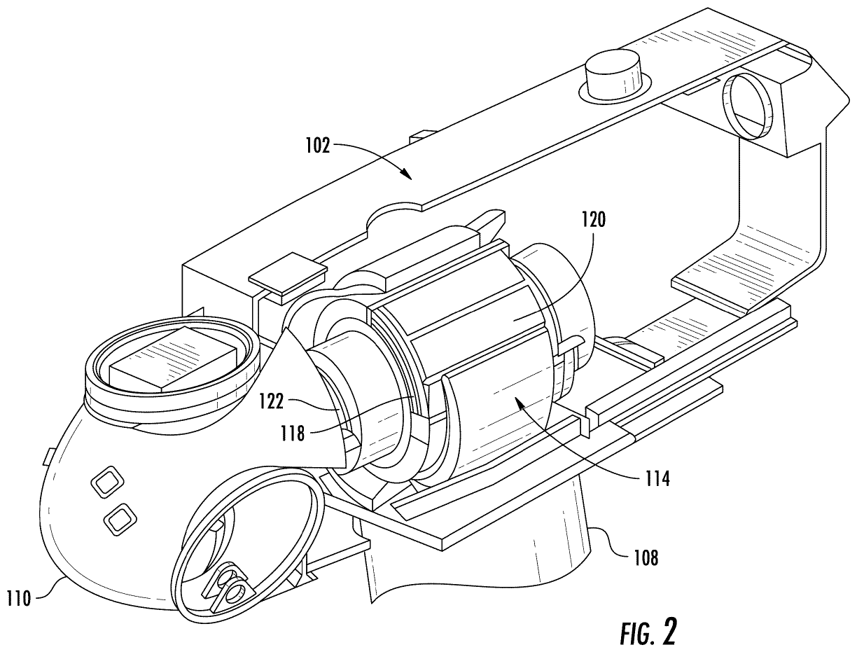

Referring now to FIG. 2, a simplified, internal view of an embodiment of the nacelle 102 of the wind turbine 100 shown in FIG. 1 is illustrated according to the present disclosure. As shown, the generator 114 is housed within the nacelle 102 and includes a field assembly 120 and an armature 118. Moreover, as shown, the generator 114 is generally coupled to the rotor 104 for producing electrical power from the rotational energy generated by the rotor 104. For example, as shown in the illustrated embodiment, the rotor 104 may include a rotor shaft 122 coupled to the hub 110 for rotation therewith. The rotor shaft 122 may, in turn, be rotatably coupled to a armature 118 of the generator 114. As is generally understood, the rotor shaft 122 may provide a torque input to the armature of the generator 114 in response to rotation of the rotor blades 112 and the hub 110. As shown, the armature 118 is within the field assembly 120 of the generator 114. However, it should be understood that the armature 118 may be external, while the field assembly 120 may be internal.

In an embodiment, electrical power may then be generated using the commonly known principles of induction by applying a torque input to the armature 118 of the generator 114. The armature 118 may then spin within a magnetic field provided by the field assembly 120 of the generator 114 (e.g., in an internal rotor configuration).

However, in other embodiments, the outer component may be the armature 118 of the generator 114, and the inner component may be the field assembly 120 of the generator 114 (e.g., in an external rotor configuration). Further, as shown, additional space may be defined between the outer component and the inner component so as to allow movement (e.g., rotation) therebetween. In other embodiments, it should be understood that the armature 118 may also be the stationary element operating within a rotating magnetic field established by rotation of the field winding.

Still referring to FIG. 2, the magnetic field generated by the armature 118 is due to the magneto-motive force (MMF) setup by the current which flows through the armature 118. The MMF has both spatial and temporal harmonics associated with it due to the discretization of the coils and the magnetic saturation within the steel structures.

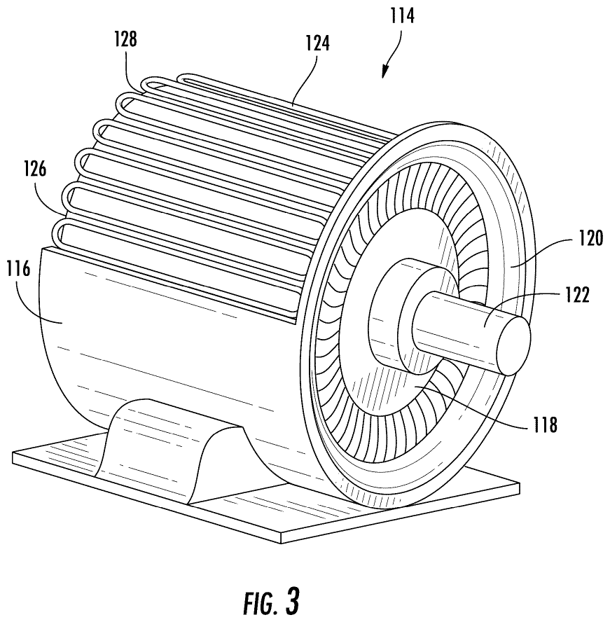

Referring now to FIG. 3, a cutaway, perspective view of an embodiment of the generator 114 according to the present disclosure is provided. In particular, as shown, the generator 114 may include a housing 116 for housing the internal components thereof, e.g., such as the armature 118 described herein that may be secured to the rotor shaft 122 and the field assembly 120 that may be secured to the stationary housing 116. Moreover, as shown, the generator 114 may also include at least one winding set. For example, as shown, the winding set(s) may include one or more current carrying conductors formed into coils 124 that may be attached to a carrier structure 126. As shown, the carrier structure 126 may be arranged circumferentially around the rotor shaft 122 and define a circumferential surface. Moreover, the carrier structure 126 may be a yoke for the field assembly 120. Alternatively, if the armature 118 is external to the field assembly 120, the carrier structure 126 may instead be a circumferential surface of the armature 118.

In addition, the coils 124 may be spaced apart from each other such that a space 128 is present between adjacent coils 124. By leaving a space 128 between each of the coils 124, a resulting opposite magnetic field (e.g., a second common polarity) may be generated in that space 128 by the natural law that forces conservation of the magnetic flux produced by the coils 124.

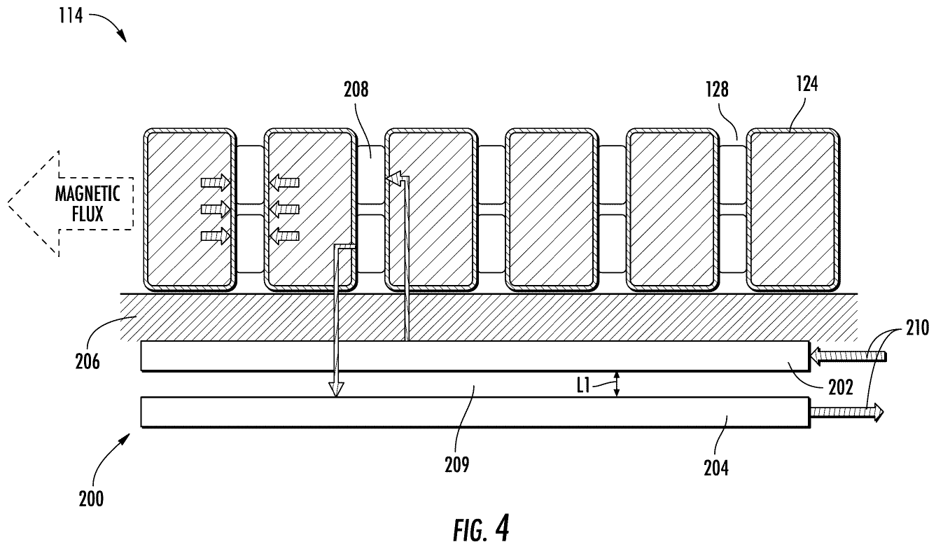

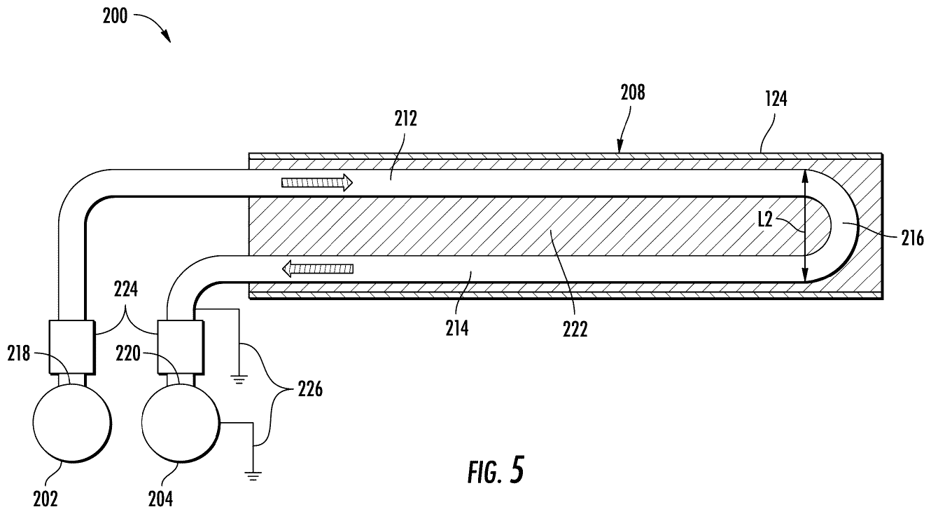

Referring now to FIGS. 4 and 5, various views of an embodiment of a cooling system 200 for the generator 114 according to the present disclosure are illustrated. As shown, the cooling system 200 generally includes an inlet manifold 202, an outlet manifold 204, a passageway 208, and a core 206. Thus, in an embodiment, the inlet manifold 202 may be configured to provide a cooling fluid 210 to the generator 114. In addition, the outlet manifold 204 may be configured to remove the cooling fluid 210 from the generator 114. The outlet manifold 204 may also be placed a length LI from the inlet manifold 202 such that a gap 209 is formed between. As such, the passageway 208 may be in fluid communication with the inlet manifold 202 and the outlet manifold 204. More specifically, as shown, the passageway 208 may be arranged between two adjacent coils 124 of the plurality of conducting coils 124. For example, if the generator 114 includes only two adjacent coils 124, one passageway 208 may be placed between the two coils 124. Furthermore, if there are four or more coils 124 in the generator 114, two or more passageways 208 may be placed between each pair of the coils 124, respectively.

The passageway 208 may be constructed from a selection of materials useful in the setting of a cooling system for a generator 114. For example, the passageway could be constructed from a metal (such as copper or aluminum), a metal alloy (such as a copper or aluminum alloy), a non-metallic material, or combinations thereof.

Referring particularly to FIG. 5, the passageway 208 may further include an inlet portion 212, an outlet portion 214, and a return portion 216. The inlet portion 212 includes a fluid inlet 218 connected to the inlet manifold 202 such that the cooling fluid 210 can flow from the inlet manifold 202 and the passageway 208. Similarly, the outlet portion 214 includes a fluid outlet 220 connected to the outlet manifold 204 such that cooling fluid 210 can flow from the passageway 208 to the outlet manifold 204. In particular, as shown, the return portion 216 generally refers to the region of the passageway 208 arranged between the inlet portion 212 and the outlet portion 214.

In addition, the fluid inlet 218 and the fluid outlet 220 may include a connector, such as a flexible connector. In such embodiments, the flexible connectors allow for expansion and/or contraction that occurs in the cooling system 200 as the temperature changes therein. Furthermore, in an embodiment, by forming the fluid inlet 218 and the fluid outlet 220 from flexible connectors, the impact on the connection between the passageway 208 and the inlet manifold 202 and/or the outlet manifold 204 caused by expansion and/or contraction of the cooling system 200 may be avoided.

Still referring to FIG. 5, the return portion 216 may define a length L2. The length L2 may be such that a gap 222 is formed between the inlet portion 212 and the outlet portion 214 such that the inlet and outlet portions 212, 214 are separated from each other.

In further embodiments, the passageway 208 may also include one or more insulators 224 and one or more ground wires 226 arranged therewith. Thus, as shown, the insulator(s) 224 may be placed on either the inlet portion 212, the outlet portion 214, or both. The insulator(s) 224 may be of particular import when either the passageway 208 or the inlet and outlet manifolds 202, 204 are made out of a conductive material such as a metallic material with optimal thermal conducting properties. For example, if the passageway 208 or the inlet and outlet manifolds 202, 204 are made out of an electrically conductive material, the insulator(s) 224 may prevent current from being channeled into from the manifolds 202, 204 into the passageway 208 or from the passageway 208 into the manifolds 202, 204. This benefit may be particularly important due to the properties of the cooling system 200. For example, if the cooling system 200 is composed of electrically conductive materials, eddy currents may develop as a result of being in proximity to the magnetic flux generated by the conductive coils 124. These eddy currents will induce localized electrical losses in the material of the passageway 208 or the manifolds, 202, 204 which will result in these components heating up. Further, the eddy currents generated can then result in the passageway 208 or manifolds 202, 204, which each have conductive properties, acting as a conductor through which the eddy currents can flow along the passageway 208 or manifolds 202, 204 through the cooling system 200. This movement of current will result in further increases of internal temperature as a consequence of the internal resistance of the cooling system 200 increasing when current flows through the cooling system 200. To address this issue, the insulator(s) 224 are configured to block the pathway for current to flow into either the inlet or outlet manifolds 202, 204 and throughout the cooling system 200.

Similarly, the insulator(s) 224, the ground wire(s) 226 may be placed on either the inlet portion 212 or the outlet portion 214. Alternatively, the inlet and outlet portions 212, 214 may be naturally electrically grounded via the means (not shown) in which they are mounted within the generator 114. In this configuration, the ground wire(s) 226 attached to 204 may not be needed.

In addition, the ground wire(s) 226 may also be placed on either the inlet manifold 202 or the outlet manifold 204. Alternatively, the inlet portion 212, the outlet portion 214, and the passageway 208 can be grounded at one point via a ground wire 226. By placing the ground wire(s) 226 in any of these configurations, a known voltage for the inlet/outlet manifolds 202, 204 or the inlet/outlet portions 212, 214 may be established.

In additional embodiments, the cooling fluid 210 may be any suitable cooling fluid, such as a cooling liquid (e.g., water, a coolant, or an antifreeze compound such as propylene glycol) or a cooling gas (e.g., air or hydrogen gas), or combinations thereof.

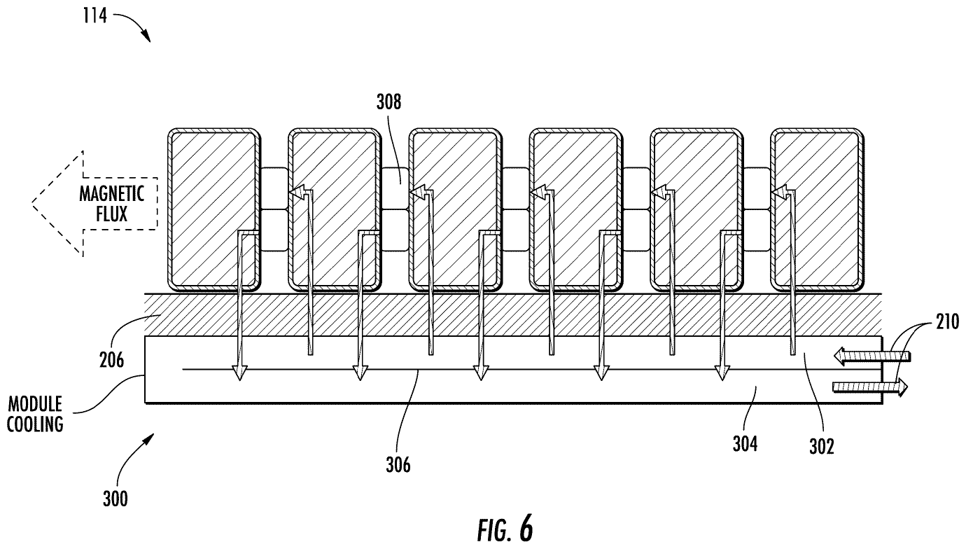

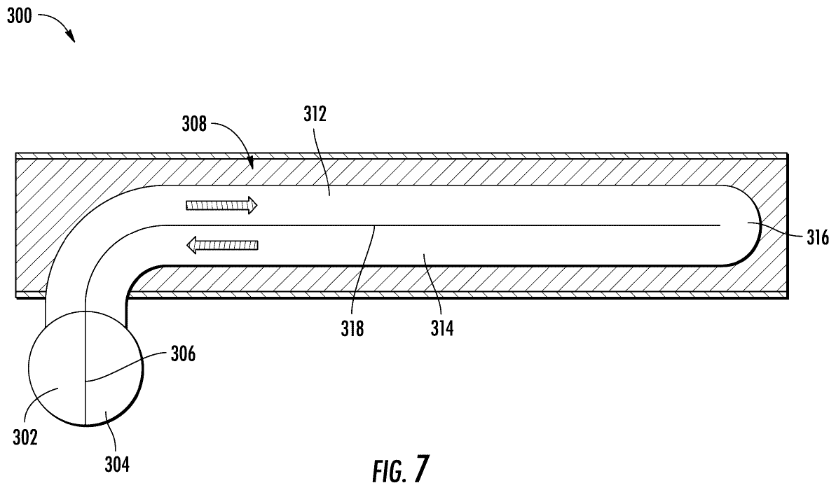

Referring now to FIGS. 6-7, various views of another embodiment of a cooling system 300 for the generator 114 according to the present disclosure are illustrated. As shown in the illustrated embodiment, the cooling system 300 may have similar components as the embodiment illustrated with reference to FIGS. 4 and 5. For example, the cooling system 300 may include a passageway 308 having an inlet portion 312, an outlet portion 314, and a return portion 316.

However, in contrast to the embodiment of FIGS. 4 and 5, the inlet manifold 302 and the outlet manifold 304 are in contact with each other. In addition, a divider 306 may be placed between the inlet manifold 302 and the outlet manifold 304. The divider 306 may be composed of a variety of materials such as a material with a particularly low thermal conductivity. For example, the material may be a metallic material such as steel with a thermal conductivity at or lower than 45 watts per meter-kelvin (W/m-K). Alternatively, the material may be a non-metallic material with a thermal conductivity that is far lower than steel. For example, the non-metallic material may be a polymer material with a thermal conductivity that has approximately 2% of the thermal conductivity of steel or a thermal conductivity at about 0.6 W/m-K to about 1 W/m-K. In selecting the divider 306 materials, thermal transfer from the outlet manifold 304 to the inlet manifold 302 may be reduced or prevented despite the inlet manifold 302 and outlet manifold being placed in such close proximity to each other.

In such embodiments, by placing the inlet manifold 302 in contact with the outlet manifold 304, the conductive potential of the cooling system 300 may be reduced as a result of the inlet manifold 302 and outlet manifold 304 no longer existing as a conductive loop or circuit. This is because any current that may develop in either the inlet manifold 302 or the outlet manifold 304 will no longer have a pathway through which the current can flow. Instead, eddy currents will be capable of developing when magnetic flux passes through the material of the inlet and outlet manifolds 302, 304, but the voltage of the inlet and outlet manifold 302, 304 will remain similar due to the manifolds 302, 304 being contacted with each other. As a consequence of the voltage being similar between the manifolds 302, 304, current will not flow either from the inlet manifold 302 to the outlet manifold 304 or vice versa.

Further, referring now to FIG. 7, the inlet portion 312 and outlet portion 314 may also be placed in contact to each other, similar to the inlet manifold 302 and the outlet manifold 304. A divider 318 may also be placed between the inlet manifold and the outlet manifold 304 for providing flow separation. Like the configuration of the inlet manifold 302, the outlet manifold 304, and the configuration divider 306, the inlet portion 312, the outlet portion 314, and the divider 318 may be capable of reducing the conductive potential of the passageway 308. For example, by placing the inlet and outlet portion 312, 314 in contact with each other, the voltage across these portions 312, 314 may be similar or identical thus reducing the amount of current or preventing current from passing through the passageway 308. Further, like the divider 306, the divider 318 may be formed from a metallic material (such as steel) or a non-metallic material (such as a polymer material) to reduce thermal transfer from the outlet portion 314 to the inlet portion 312. It should be understood that although the divider 306 and divider 318 are discussed as separate components, the divider 306 and divider 318 may be integrated with each other to form a singular divider that divides both the inlet and outlet manifolds 302, 304 and the inlet and outlet portions 312, 314.

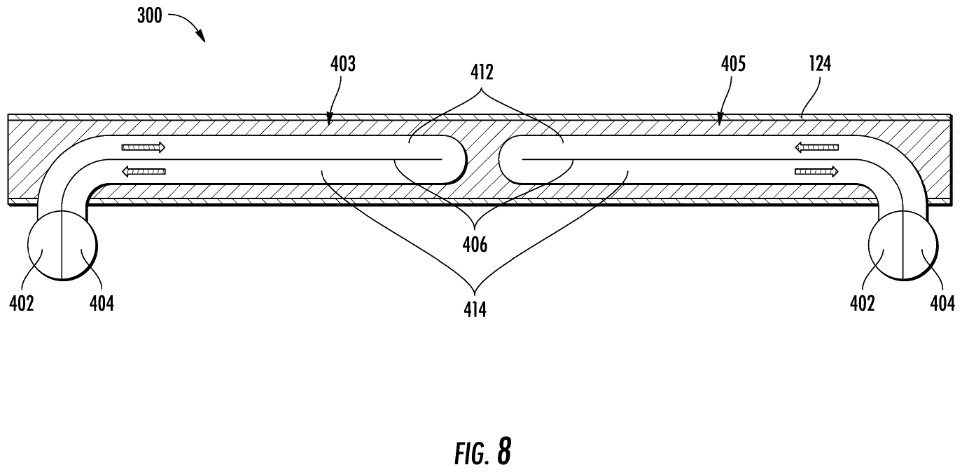

Referring now to FIG. 8, a side view of yet another embodiment of a cooling system 400 having multiple passageways 403, 405 is shown. In particular, as shown, the cooling system 400 may include a first passageway 403 and a second passageway 405. However, it should be understood that more than two passageways may be placed between two adjacent coils 124. Further, both the first passageway 403 and the second passageway 405 can be connected to the inlet manifold 402 and the outlet manifold 404 as shown and described herein. One benefit to providing a first and second passageway 403, 405 is that a greater rate of mass flow of the cooling fluid may be achieved resulting in greater overall cooling power for the same overall pressure between the inlet and outlet manifolds 402, 404. Furthermore, as shown, the inlet portion 412 and outlet portion 414 may be placed in contact with each other with a divider 406 placed therebetween similar to the embodiment of FIGS. 6 and 7.

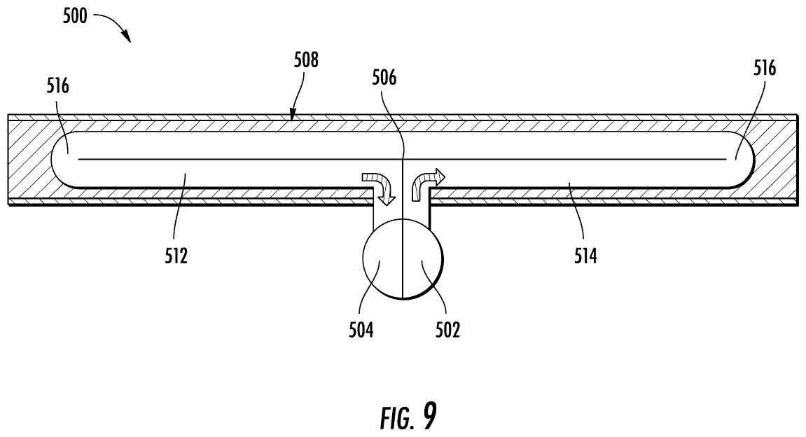

Referring now to FIG. 9, a side view of still another embodiment of a cooling system 500 having a single passageway 508 with an inlet portion 512 and an outlet portion 514 defined using divider 506 is illustrated. As shown, the passageway 508 has two return portions 516 to allow the cooling fluid entering from the inlet manifold 502 to travel through the passageway 508 and return to the outlet manifold 504 through the single passageway 508.

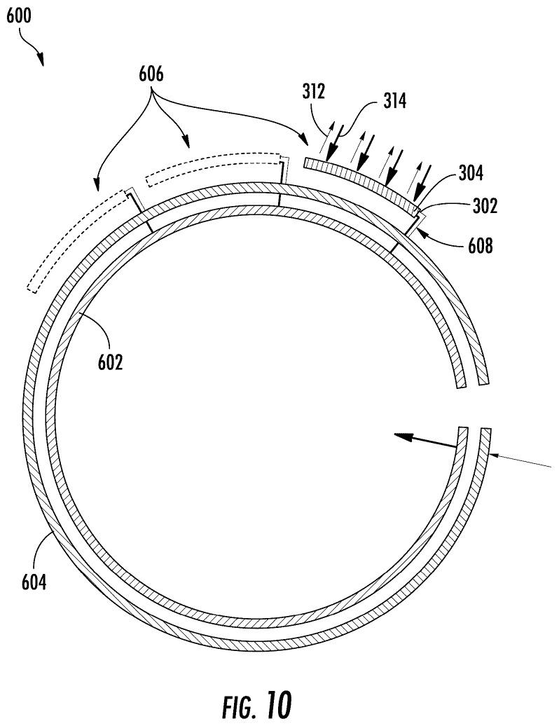

Referring now to FIG. 10, a schematic diagram of an embodiment of another cooling system. As shown, the cooling system 600 includes a cooling inlet 604, a cooling outlet 602, and cooling module(s) 606. The cooling module(s) 606 may be or include any of the aforementioned cooling systems 200, 300, 400, 500, or 600. For example, if the cooling module 606 is the cooling system 300, the cooling inlet 604 may be connected to the inlet manifold 302 (which is then connected to the inlet portion 312) and the cooling outlet 602 may be connected to the outlet manifold 304 (which is then connected to the outlet portion 314). The connections between these respective components may be formed using connectors 608. The connectors 608 may be flexible connectors similar to the flexible connectors used to form the fluid inlet and outlet 218, 220 of the cooling system 200. In addition, any number of cooling module(s) 606 may be provided. Moreover, if the cooling system 600 is to be used with a generator such as the generator 114, the cooling module(s) 606 may be placed along the entire circumference of the generator. By providing a cooling inlet 604, cooling outlet 602, and cooling module(s) 606 in this manner, the cooling module(s) 606 (which may include cooling systems 200, 300, 400, 500, or 600) may be more easily manufactured and arranged within an electrical machine, such as the generator 114, as a result of the cooling module(s) 606 having a shortened circumferential span.

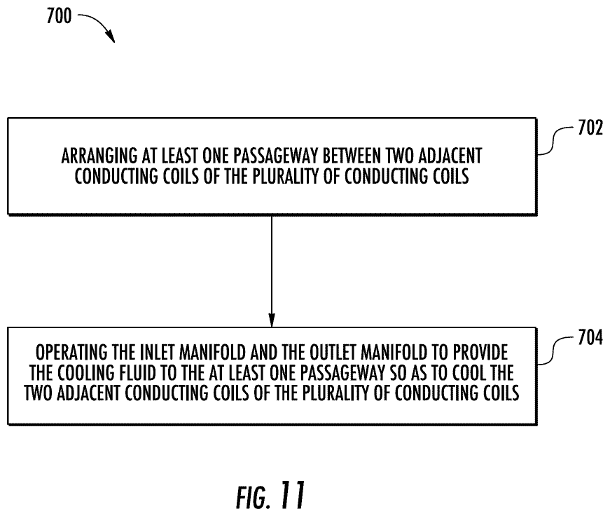

Referring now to FIG. 11, a flow diagram of an embodiment of a method 700 of cooling a generator having a plurality of conducting coils is illustrated. It should be understood that the method 700 may be implemented using, for instance, the cooling systems 300, 400, 500, or 600 described herein with respect to FIGS. 4-10. FIG. 11 depicts steps performed in a particular order for purposes of illustration and discussion. Those of ordinary skill in the art, using the disclosures provided herein, will understand that various steps of the method 700, or any of the methods disclosed herein, may be adapted, modified, rearranged, performed simultaneously, or modified in various ways without deviating from the scope of the present disclosure.

As shown at (702), the method 700 includes arranging at least one passageway between two adjacent conducting coils of the plurality of conducting coils. The passageway(s) may be in fluid communication with an inlet manifold that provides cooling fluid to the generator and an outlet manifold that removes the cooling fluid from the generator. During this step, the at least one passageway may define an inlet portion including a fluid inlet in fluid communication with the inlet manifold, an outlet portion including a fluid outlet in fluid communication with the outlet manifold, and a return portion arranged between the inlet portion and the outlet portion. In addition, the return portion arranged between the inlet portion and the outlet portion may define a length such that the inlet portion and the outlet portion are arranged in contact with each other along respective lengths of the inlet and outlet portions so as to provide electrical insulation. As shown at (704), the method 700 further includes operating the inlet manifold and the outlet manifold to provide the cooling fluid to the passageway(s) so as to cool the two adjacent conducting coils of the plurality of conducting coils.

Various aspects and embodiments of the present disclosure are defined by the following numbered clauses:

Clause 1. An electrical machine, comprising:
a shaft;
a carrier structure arranged circumferentially around the shaft and defining a circumferential surface;
a plurality of conducting coils secured to the carrier structure; and
a cooling system, comprising:
   an inlet manifold for providing a cooling fluid to the electrical machine;
   an outlet manifold for removing the cooling fluid from the electrical machine; and
   at least one passageway in fluid communication with the inlet manifold and the outlet manifold, the at least one passageway arranged between two adjacent conducting coils of the plurality of conducting coils, the at least one passageway defining an inlet portion comprising a fluid inlet in fluid communication with the inlet manifold, an outlet portion comprising a fluid outlet in fluid communication with the outlet manifold, and a return portion arranged between the inlet portion and the outlet portion,
   wherein the return portion defines a length such that the inlet portion and the outlet portion are arranged in contact with each other along respective lengths of the inlet and outlet portions so that a conductive potential of the at least one passageway is reduced.

Clause 2. The electrical machine of clause 1, wherein the carrier structure is an armature or a yoke of a field assembly.

Clause 3. The electrical machine of any of the preceding clauses, further comprising a first divider arranged along the respective lengths of the inlet and outlet manifolds for providing flow separation between the inlet and outlet manifolds.

Clause 4. The electrical machine of clause 3, wherein the first divider is constructed of a material with a thermal conductivity lower than about 45 watts per meter-kelvin (W/m-K).

Clause 5. The electrical machine of clause 3, wherein the first divider is constructed of a non-metallic material.

Clause 6. The electrical machine of any of the preceding clauses, further comprising a cooling inlet and a cooling outlet wherein the cooling system defines a module, wherein at least one module is connected to the cooling inlet and the cooling outlet.

Clause 7. The electrical machine of clause 6, wherein the cooling inlet is connected to the inlet manifold of the at least one module and the cooling outlet is connected to the outlet manifold of the at least one module.

Clause 8. The electrical machine of clause 7, wherein the connections between the cooling inlet and outlet and the inlet and outlet manifolds comprise flexible connectors.

Clause 9. The electrical machine of any of the preceding clauses, further comprising a second divider arranged along the respective lengths of the inlet and outlet portions for providing flow separation between the inlet and outlet portions.

Clause 10. The electrical machine of clause 9, wherein the second divider is constructed of a material with a thermal conductivity lower than about 45 watts per meter-kelvin (W/m-K).

Clause 11. The electrical machine of clause 9, wherein the second divider is constructed of a non-metallic material.

Clause 12. The electrical machine of any of the preceding clauses, wherein the cooling fluid comprises at least one of water, coolant, antifreeze, gas, or combinations thereof.

Clause 13. The electrical machine of any of the preceding clauses, wherein the inlet and outlet manifolds and the inlet and outlet portions are constructed of an electrically conductive material.

Clause 14. The electrical machine of any of the preceding clauses, wherein the cooling system further comprises at least two passageways in fluid communication with the inlet manifold and the outlet manifold, the at least two passageways arranged between two adjacent conducting coils of the plurality of conducting coils.

Clause 15. A method of cooling an electrical machine having a plurality of conducting coils, the method comprising:
arranging at least one passageway between two adjacent conducting coils of the plurality of conducting coils, the at least one passageway being in fluid communication with an inlet manifold that provides cooling fluid to the electrical machine and an outlet manifold that removes the cooling fluid from the electrical machine, wherein the at least one passageway defines an inlet portion comprising a fluid inlet in fluid communication with the inlet manifold, an outlet portion comprising a fluid outlet in fluid communication with the outlet manifold, and a return portion arranged between the inlet portion and the outlet portion, wherein the return portion defines a length such that the inlet portion and the outlet portion are arranged in contact with each other along respective lengths of the inlet and outlet portions so as to provide electrical insulation thereto; and
operating the inlet manifold and the outlet manifold to provide the cooling fluid to the at least one passageway so as to cool the two adjacent conducting coils of the plurality of conducting coils.

Clause 16. The method of clause 15, further comprising arranging a first divider arranged along the respective lengths of the inlet and outlet manifolds for providing flow separation between the inlet and outlet portions.

Clause 17. The method of clauses 15-16, further comprising arranging a second divider arranged along the respective lengths of the inlet and outlet portions for providing flow separation between the inlet and outlet portions.

Clause 18. The method of clause 16, wherein the first divider comprises a non-metallic material, wherein the non-metallic material comprises a thermal conductivity lower than about 45 watts per meter-kelvin (W/m-K).

Clause 19. The method of clause 15-18, further comprising arranging at least two passageways between two adjacent conducting coils of the plurality of conducting coils, the at least two passageways being in fluid communication with an inlet manifold that provides cooling fluid to the electrical machine and an outlet manifold that removes the cooling fluid from the electrical machine.

Clause 20. A wind turbine, comprising:
a generator, comprising:
   a shaft;
   a carrier structure arranged circumferentially around the shaft and defining a circumferential surface;
   a plurality of conducting coils secured to the carrier structure; and
   a cooling system, comprising:
      an inlet manifold for providing a cooling fluid to the generator;
      an outlet manifold for removing the cooling fluid from the generator; and
   at least one passageway in fluid communication with the inlet manifold and the outlet manifold, the at least one passageway arranged between two adjacent conducting coils of the plurality of conducting coils, the at least one passageway defining an inlet portion comprising a fluid inlet in fluid communication with the inlet manifold, an outlet portion comprising a fluid outlet in fluid communication with the outlet manifold, and a return portion arranged between the inlet portion and the outlet portion,
   wherein the return portion defines a length such that the inlet portion and the outlet portion are arranged in contact with each other along respective lengths of the inlet and outlet portions so that a conductive potential of the at least one passageway is reduced.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An electrical machine, comprising:
a shaft;
a carrier structure arranged circumferentially around the shaft and defining a circumferential surface;
a plurality of conducting coils secured to the carrier structure; and
a cooling system, comprising:
an inlet manifold for providing a cooling fluid to the electrical machine;
an outlet manifold for removing the cooling fluid from the electrical machine; and
at least one passageway in fluid communication with the inlet manifold and the outlet manifold, the at least one passageway arranged between two adjacent conducting coils of the plurality of conducting coils, the at least one passageway defining an inlet portion comprising a fluid inlet in fluid communication with the inlet manifold, an outlet portion comprising a fluid outlet in fluid communication with the outlet manifold, and a return portion arranged between the inlet portion and the outlet portion,
wherein the return portion defines a length such that the inlet portion and the outlet portion are arranged in contact with each other along respective lengths of the inlet and outlet portions so that a conductive potential of the at least one passageway is reduced.

2. The electrical machine of claim 1, wherein the carrier structure is an armature or a yoke of a field assembly.

3. The electrical machine of claim 1, further comprising a first divider arranged along the respective lengths of the inlet and outlet manifolds for providing flow separation between the inlet and outlet manifolds.

4. The electrical machine of claim 3, wherein the first divider is constructed of a material with a thermal conductivity lower than about 45 watts per meter-kelvin (W/m-K).

5. The electrical machine of claim 3, wherein the first divider is constructed of a non-metallic material.

6. The electrical machine of claim 1, further comprising a cooling inlet and a cooling outlet wherein the cooling system defines a module, wherein at least one module is connected to the cooling inlet and the cooling outlet.

7. The electrical machine of claim 6, wherein the cooling inlet is connected to the inlet manifold of the at least one module and the cooling outlet is connected to the outlet manifold of the at least one module.

8. The electrical machine of claim 7, wherein the connections between the cooling inlet and outlet and the inlet and outlet manifolds comprise flexible connectors.

9. The electrical machine of claim 1, further comprising a second divider arranged along the respective lengths of the inlet and outlet portions for providing flow separation between the inlet and outlet portions.

10. The electrical machine of claim 9, wherein the second divider is constructed of a material with a thermal conductivity lower than about 45 watts per meter-kelvin (W/m-K).

11. The electrical machine of claim 9, wherein the second divider is constructed of a non-metallic material.

12. The electrical machine of claim 1, wherein the cooling fluid comprises at least one of water, coolant, antifreeze, gas, or combinations thereof.

13. The electrical machine of claim 1, wherein the inlet and outlet manifolds and the inlet and outlet portions are constructed of an electrically conductive material.

14. The electrical machine of claim 1, wherein the cooling system further comprises at least two passageways in fluid communication with the inlet manifold and the outlet manifold, the at least two passageways arranged between two adjacent conducting coils of the plurality of conducting coils.

15. A method of cooling an electrical machine having a plurality of conducting coils, the method comprising:
arranging at least one passageway between two adjacent conducting coils of the plurality of conducting coils, the at least one passageway being in fluid communication with an inlet manifold that provides cooling fluid to the electrical machine and an outlet manifold that removes the cooling fluid from the electrical machine, wherein the at least one passageway defines an inlet portion comprising a fluid inlet in fluid communication with the inlet manifold, an outlet portion comprising a fluid outlet in fluid communication with the outlet manifold, and a return portion arranged between the inlet portion and the outlet portion, wherein the return portion defines a length such that the inlet portion and the outlet portion are arranged in contact with each other along respective lengths of the inlet and outlet portions so as to provide electrical insulation thereto; and
operating the inlet manifold and the outlet manifold to provide the cooling fluid to the at least one passageway so as to cool the two adjacent conducting coils of the plurality of conducting coils.

16. The method of claim 15, further comprising arranging a first divider arranged along the respective lengths of the inlet and outlet manifolds for providing flow separation between the inlet and outlet portions.

17. The method of claim 15, further comprising arranging a second divider arranged along the respective lengths of the inlet and outlet portions for providing flow separation between the inlet and outlet portions.

18. The method of claim 16, wherein the first divider comprises a non-metallic material, wherein the non-metallic material comprises a thermal conductivity lower than about 45 watts per meter-kelvin (W/m-K).

19. The method of claim 15, further comprising arranging at least two passageways between two adjacent conducting coils of the plurality of conducting coils, the at least two passageways being in fluid communication with an inlet manifold that provides cooling fluid to the electrical machine and an outlet manifold that removes the cooling fluid from the electrical machine.

20. A wind turbine, comprising:
a generator, comprising:
a shaft;
a carrier structure arranged circumferentially around the shaft and defining a circumferential surface;
a plurality of conducting coils secured to the carrier structure; and
a cooling system, comprising:
an inlet manifold for providing a cooling fluid to the generator;
an outlet manifold for removing the cooling fluid from the generator; and
at least one passageway in fluid communication with the inlet manifold and the outlet manifold, the at least one passageway arranged between two adjacent conducting coils of the plurality of conducting coils, the at least one passageway defining an inlet portion comprising a fluid inlet in fluid communication with the inlet manifold, an outlet portion comprising a fluid outlet in fluid communication with the outlet manifold, and a return portion arranged between the inlet portion and the outlet portion,
wherein the return portion defines a length such that the inlet portion and the outlet portion are arranged in contact with each other along respective lengths of the inlet and outlet portions so that a conductive potential of the at least one passageway is reduced.
